(19) United States
(12) Patent Application Publication
(10) Pub. No.: US 2015/0300561 A1
(43) Pub. Date: Oct. 22, 2015

(54) FASTENING ELEMENT FOR THE FIXING OF FASTENING POINTS AND/OR STATIC LOADS ON METAL PROFILES

(71) Applicant: SAFE Patentverwaltungs- und Verwertungs GmbH, Spital/Pyhrn (AT)

(72) Inventors: Sepp Anton Aichholzer, Spittal/Drau (AT); Karl-Heinz Canins, Hermagor (AT); Rudolf Reitegger, Admont (AT)

(73) Assignee: SAFE PATENTVERWALTUNGS- UND VERWERTUNGS GMBH, Spital/Pyhrn (AT)

(21) Appl. No.: 14/443,415

(22) PCT Filed: Nov. 19, 2013
(86) PCT No.: PCT/EP2013/074154

§ 371 Date: May 18, 2015

(30) Foreign Application Priority Data
Nov. 19, 2012 (AT) GM 447/2012

(51) Int. Cl. F16M 13/02; E05D 5/14; E05D 3/12

(52) U.S. Cl. CPC F16M 13/022; E05D 3/12; E05D 5/14

(57) ABSTRACT

Fastening element for the fixation of anchor points, which are especially suited to the supporting of dynamic loads, and/or static loads on metal profiles, especially those of reinforced steel wall systems, facing formwork, or suspended ceilings. In order to prevent an overloading and deformation of the metal profiles in event of a protected fall, the fastening element includes an angle-shaped bracket, with a first leg and a second leg, wherein at least one connector is arranged on the first leg for connecting the anchor point and/or the static load to the fastening element and the at least one connector preferably has an internal thread, wherein the second leg has at least one opening for screwing the second leg to a metal profile and wherein the second leg is provided with a corrugation at least for a portion.

### FIELD OF THE INVENTION

The invention concerns a fastening element for the fixation of anchor points, which are especially suited to the supporting of dynamic loads, and/or static loads on metal profiles, especially those of reinforced steel wall systems, facing formwork, or suspended ceilings.

### PRIOR ART

Fall protection systems are used to prevent falls when the fall height can result in injuries. This can be done by the use of protective means such as scaffolds, catching nets or lifelines, with anchor points being provided for these protection means. One usually consults standard EN 795 for the calculation or design of anchor points and their fastening.

There are no known systems on the market which make it possible to mount anchor points of class A1 according to EN 795 in or on reinforced steel wall systems, facing formwork or suspended ceilings, since the permissible cantilevered or suspended loads for these structural parts according to the standard are far less than the static and dynamic point loads occurring in the protection of people against falling according to EN 795. Reinforced steel wall systems, facing formwork, and suspended ceilings are relatively light and fragile structural parts which by their nature are designed essentially as space partitioning or paneling, but not as critically static load bearing. Accordingly, it is only possible to apply horizontal or vertical single loads to a limited degree, and standardized static or dynamic loads such as occur in the protection of people against falling cannot readily be supported by these structural parts.

The main reason for this is that anchor points for securing of people against falling are usually rigidly joined to the underlying structures, which in the case of the aforementioned structural parts consist of metal profiles. The anchor points themselves with few exceptions do not allow any critical deformation under load, which results in substantial forces of reaction and unacceptably large deformations in the metal profiles.

### OBJECT OF THE INVENTION

Therefore, the object which the invention proposes to achieve is to create a possibility for the fixation of anchor points, which are especially suited to supporting of dynamic loads, and/or static loads on metal profiles, especially reinforced steel wall systems, facing formwork, or suspended ceilings, which prevents overloading and unacceptably large deformation of the metal profiles in the case of the static and especially dynamic point loads which occur in the case of protecting people against falling in accordance with EN 795.

### SUMMARY OF THE INVENTION

The essence of the invention for the achieving the above object is to provide a fastening element for the fixation of anchor points, which are suitable especially for the supporting of dynamic loads, and/or static loads on metal profiles, especially reinforced steel wall systems, facing formwork, or suspended ceilings, which has an energy-absorbing functionality. Thus, the dynamic forces occurring during fall prevention can be dampened so much that the remaining loads do not result in any overstraining or unacceptably large deformation of the metal profiles. The dynamic forces are preferably channeled through anchor points, while an anchor point strictly speaking also itself constitutes an—extremely slight—static load, of course. However, by static load is meant much greater loads, not yet resulting in an unacceptably large deformation of the metal profiles, such as a boiler or a wash basin, or more properly their weight.

For the dampening of dynamic forces, the fastening element of the invention comprises an angle-shaped bracket with a first leg and a second leg, the two legs subtending an angle, preferably a right angle, so that the cross section of the angle-shaped bracket is preferably L-shaped. For the connecting of anchor points or a static load, the first leg has at least one connection means. Since the connection to the anchor point is usually produced by screw fastening, the connection means preferably has an inner thread. In particular, however, for the supporting of static loads or suspended loads it is also conceivable to provide a bayonet seal or the like instead of a screw fastening.

The second leg is used to connect the fastening element to the metal profile. Typically, metal profiles are used that are designed according to DIN 18182-1 or DIN EN 14195. These metal profiles usually have holes by means of which the metal profiles can be joined or screwed together, without having to drill holes at the construction site.

So-called UA metal profiles, which are used as reinforcement in metal wall systems, have at least one row of oblong holes along the lengthwise direction of the particular metal profile. Depending on the height of the metal profile, an additional row of oblong holes can be provided, while a row of round holes can be arranged between the two rows of oblong holes. The sheet thickness of the UA metal profiles is usually a uniform 2 mm.

For the connection of the fastening element to the metal profile, the second leg has at least one opening, through which a screw fastening can be done making use of the holes, such as the oblong holes, of the metal profile.

In order to endow the fastening element with the functionality of an energy absorber, the second leg has a corrugation, at least for a portion. This facilitates a plastic deformation of the second leg in the case of a loading, especially a dynamic loading, in that the corrugation can be compressed and stretched out like an accordion. Due to this plastic deformation, energy is absorbed, which reduces the load acting on the metal profile.

Accordingly, a fastening element is provided by the invention for the fixation of anchor points, which are especially suited to supporting of dynamic loads, and/or static loads on metal profiles, especially reinforced steel wall systems, facing formwork, or suspended ceilings, comprising an angle-shaped bracket with a first leg and a second leg, wherein at least one connection means is arranged on the first leg for connecting the anchor point and/or the static load to the fastening element and the at least one connection means preferably has an internal thread, wherein the second leg has at least one opening for the screw fastening of the second leg to a metal profile and wherein the second leg is provided with a corrugation, at least for a portion.

The metal profiles, especially UA metal profiles, can typically be singly, doubly or triply paneled. The paneling generally consists of gypsum plasterboard or gypsum fiberboard with a thickness of 1.25 cm to 1.5 cm. The paneling is fastened with an actual overall thickness resulting from the number of layers on a face side of the metal profile, usually by screw fastening. In order to adjust the position of the anchor point in relation to the actually resulting overall thickness of the paneling, in one preferred embodiment of the fastening element according to the invention there are two openings provided in the second leg, configured as oblong holes. The oblong holes allow a shifting of the fastening element in one direction parallel to the (overall) thickness of the paneling or in a direction normal to the face side of the metal profile, until the desired position is found. In this position, the fastening element is then fixed by tightening up the screws led through the oblong holes of the fastening element and the holes, preferably oblong holes, of the metal profile.

The aforementioned energy absorption by compression or stretching of the corrugation of the second leg increases or decreases the amplitude of the corrugation, wherein the amplitude extends out from a plane of the second leg. Wave peaks characterize the amplitude in a direction pointing away from the plane of the second leg; wave valleys characterize the amplitude in the opposite direction.

For a simple production of the corrugation it has proven to be convenient for the wave peaks and valleys to extend in a straight line. In other words, points of equal phase of the fundamental wave lie on straight lines. The direction of extent of the wave peaks and valleys is parallel to these lines.

The two legs each have an inner surface, and the inner surfaces intersect along one edge. The inner surfaces are oriented such that they subtend an angle, measured in a plane normal to the edge, of less than 180°.

In order to ensure a corrugation which is especially easy to produce, in a preferred embodiment of the fastening element of the invention the corrugation has a constant wavelength. Of course, however, it is also conceivable to provide a variable wavelength, for example, in order to accomplish a progression in the dampening of the forces occurring during a fall.

In order to absorb especially a lot of energy, in another preferred embodiment of the fastening element of the invention the corrugation extends over the entire second leg.

Besides the plastic deformation of the corrugation of the second leg, yet another mechanism can be utilized for energy absorption. In this case, a rotation of the fastening element occurs against the friction acting between the second leg and the metal profile when a load is acting with sufficiently large direction component parallel to the edge. In this way, the energy being absorbed is converted into heat and the load on the metal profile is reduced.

In order to make such a rotation possible, in one especially preferred embodiment of the fastening element of the invention the two oblong holes are curved, and the curvature of the one oblong hole is opposite the curvature of the other oblong hole.

In order to retain at the same time the aforementioned possibility of shifting the fastening element, in another preferred embodiment of the fastening element of the invention the two oblong holes each run along an imaginary circular arc and the imaginary circular arcs have no common midpoint of the circle. Accordingly, the imaginary circular arcs have relatively large radii of curvature.

The oblong holes can be arranged so that extensions of the one imaginary circular arc do not intersect extensions of the other imaginary circular arc, but rather the other imaginary circular arc itself. The arrangement of the oblong holes is usually such that a common surface is subtended by the imaginary circular arcs and extensions based on the mentioned intersections. Therefore, in another preferred embodiment of the fastening element of the invention extensions of the imaginary circular arcs each time intersect the other imaginary circular arc and/or the extension of the other imaginary circular arc.

If the fastening element is mounted on the metal profile and as yet no dynamic loading has occurred, the edge usually runs parallel to the face side of the metal profile. Upon loading, forces typically act with a dominant directional component parallel to the face side of the metal profile and thus parallel to the edge. This parallel directional component brings about the above-described rotation of the fastening element. At latest after the rotation has occurred, the load has a directional component which is normal to the edge. Now, in order to enable an energy absorption by compression or stretching of the corrugation, the extension direction of the wave peaks and valleys of the corrugation should not be normal to the edge, however. Accordingly, in another preferred embodiment of the fastening element of the invention the corrugation has an amplitude which extends out from a plane of the second leg and is formed by wave peaks and valleys, while the extension of the wave peaks and valleys is in a straight line, and the extension direction of the wave peaks and valleys encloses with one edge an angle not equal to 90°, measured in the plane of the second leg, or runs parallel to the edge, while along the edge an inner surface of the first leg and an inner surface of the second leg intersect and wherein the inner surfaces enclose an angle less than 180°, measured in a plane which is normal to the edge.

Therefore, at latest after the rotation of the fastening element the following situation exists: looking along the directional component of the load running parallel to the edge, in a first deformation region of the second leg, there is a stretching of the corrugation, and in a following second deformation region of the second leg there is a compression of the corrugation. The oblong hole lying in the first deformation region shall be called hereafter the first oblong hole, and the oblong hole lying in the second deformation region the second oblong hole.

When screwing the second leg together with the metal profile, the second leg is pressed with the corrugation against the metal profile. If a sufficiently large nut or washer or a sufficiently large screw head of the screw used for the fastening is selected, an elastic deformation of the second leg will occur in the region of the screw connection, decreasing the amplitude of the corrugation as compared to the unscrewed condition. Typically, for a sufficient size, the diameter of the nut, the washer, or the screw head—depending on which of these parts makes contact with the second leg—should correspond to at least half a wavelength. Therefore, when using the fastening element of the invention for the fixation of anchor points, which are especially suited to supporting of dynamic loads, and/or static loads on metal profiles, especially reinforced steel wall systems, facing formwork, or suspended ceilings, the second leg is elastically deformed upon being screwed together with the metal profile and the amplitude is reduced at least for a portion as compared to the unscrewed state.

In order to ensure on the one hand the required elasticity and on the other hand the necessary plastic deformability of the second leg, in one preferred embodiment of the fastening element of the invention the angle-shaped bracket is made of metal.

During the above-described rotation of the fastening element, the screw in the second oblong hole acts as a pivot point and the first oblong hole as a guide. As mentioned above, energy is dissipated by being converted into heat, since the rotation occurs under friction. This first rotation clearly ends when the end of the first oblong hole has been reached.

Depending on the remaining load and the precise position of the screw in the second oblong hole, as a further consequence there may be a second, additional rotation, wherein the screw in the first oblong hole then acts as a pivot point. This second rotation ends when the end of the second oblong hole is reached.

Finally, there may also be a linear slippage of the fastening element along the metal profile, wherein the oblong holes of the metal profile serve as a guide. Here as well, energy is dissipated by conversion into heat, since this slippage also occurs under friction between the second leg and the metal profile. The exact sequence of the first rotation, the second rotation of the linear slippage, and the plastic deformation by compression/stretching of the corrugation may vary, wherein details may play a role—such as the surface texture of the metal profile, the precise tightening torque of the screw or nut used to fasten the second leg to the metal profile, the precise directional components of the applied load and their development over time, etc. The stiffness of the particular paneling also plays a role in these events, but is left out from the above discussion.

As already mentioned, connection means with internal thread are preferably provided for connecting the anchor point to the fastening element. These connection means must be fixed immovably on the first leg, since they are no longer accessible after the paneling is mounted. Therefore, threaded sleeves which are fixed to the first leg, for example by welding, are especially suitable as the connection means. A low-cost alternative is insert nuts. Accordingly, in a preferred embodiment of the fastening element of the invention two threaded sleeves or insert nuts are fixed to the inner surface of the first leg as connection means.

In order to enable an optimal transmission of the load from the anchor point or the static load to the fastening element, the anchor point should make contact with the first leg or the fastening element by the largest possible area. Therefore, in a further preferred embodiment of the fastening element of the invention a connection plate is arranged on the first leg, in order to enable a planar bearing of the anchor point and/or the static load against the fastening element.

The connection plate can be fixed to the first leg as a separately manufactured part. But of course it is also conceivable in one space-saving alternative for the connection plate to be formed by the first leg itself. Accordingly, in one preferred embodiment of the fastening element of the invention the connection plate is formed by the first leg.

In order to connect the anchor point or the static load to the inner threads of the connection means when a connection plate is present, in one preferred embodiment of the fastening element of the invention the connection plate has a mounting opening above each of the inner threads of the threaded sleeves or insert nuts to enable the connecting of the anchor point and/or the static load to the fastening element by a screw fastening. To enable a screw fastening without skewing in this case, the axes of the inner threads are normal to the connection plate.

An especially optically appealing solution is the recessed mounting of the anchor point in a box-like container. Therefore, in one preferred embodiment of the fastening element of the invention, the connection plate is arranged on the back side of a box-like container or forms its back side, while the box-like container furthermore has a front side and an opening is arranged on the front side.

The box-like container furthermore helps when plastering over the fastening element. For this, a mounting core preferably made of plastic is placed in the box-like container, filling up the box-like container and closing the opening so that a flat front side results. It is also conceivable for the mounting core to consist of a nonflammable material of class A1 per ISO 1182, in order to contribute to the first resistance of the overall structure. After the plastering, the mounting core can be removed and the anchor point be put in place. If no anchor point is needed for the time being, the mounting core can also be left in the box-like container and be painted over, so that the fastening element present is not visually noticeable.

The fastening element of the invention is suitable not only for the fixation of anchor points for supporting of dynamic loads. The fastening element can also support static loads whose magnitude is such that no plastic deformations as described above will occur. Such static loads are produced, for example, by the installation of ventilation ducts, air conditioners, boilers or wash basins on the fastening element. It is possible to leave the mounting core in the box-like container by making the mounting core itself of pressure-resistant material, in order to support the pressure forces caused by the screw fastening. In this case, the mounting core preferably has plugs which can be removed to make possible access to threaded sleeves or insert nuts.

### BRIEF DESCRIPTION OF THE FIGURES

The invention will now be explained in greater detail with the help of an exemplary embodiment. The drawings are exemplary and are meant to explain the notion of the invention, but in no way narrow it or even definitively represent it.

The drawings show:

FIG. 1, a side view of a fastening element according to the invention, looking at an inner surface of a second leg of the fastening element

FIG. 2, a side view of the fastening element of FIG. 1, looking in the opposite direction

FIG. 3, a view of the fastening element of FIG. 1

FIG. 4, a front view of the fastening element of FIG. 1 looking at a box-like container of the fastening element

FIG. 5, a front view of the fastening element of FIG. 1, looking at the box-like container, where one anchor point is mounted

FIG. 6, a side view of a metal profile with three fastening elements from FIG. 1 screwed onto it, each time with a different distance between a front side of the box-like container and a front face of the metal profile

FIG. 7, a side view similar to FIG. 6, but only with one fastening element screwed onto the metal profile, being in a rotated position

### WAYS OF IMPLEMENTING THE INVENTION

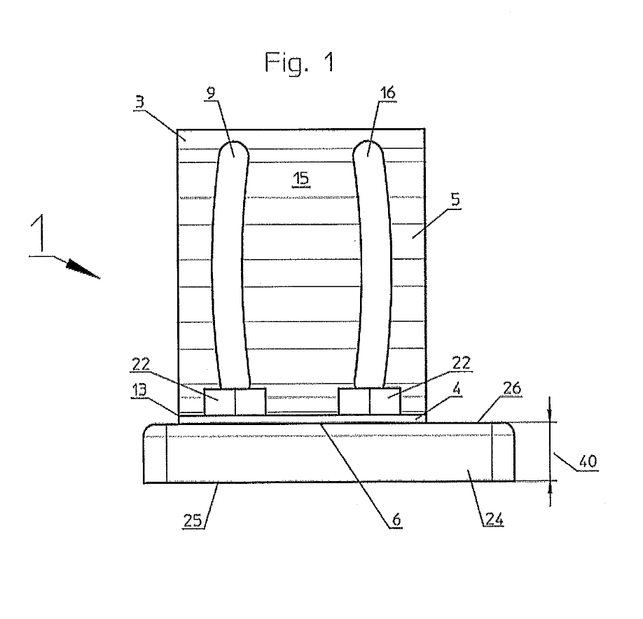

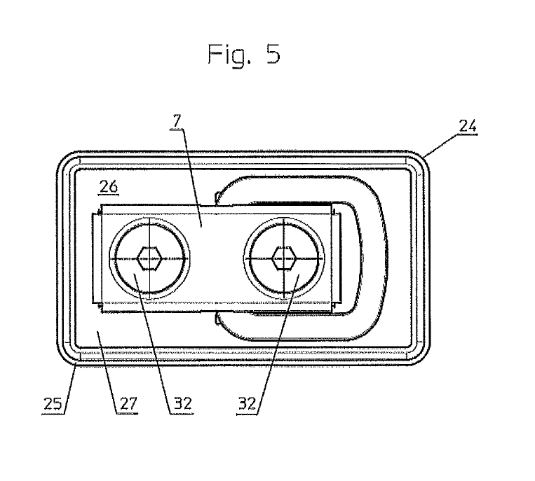

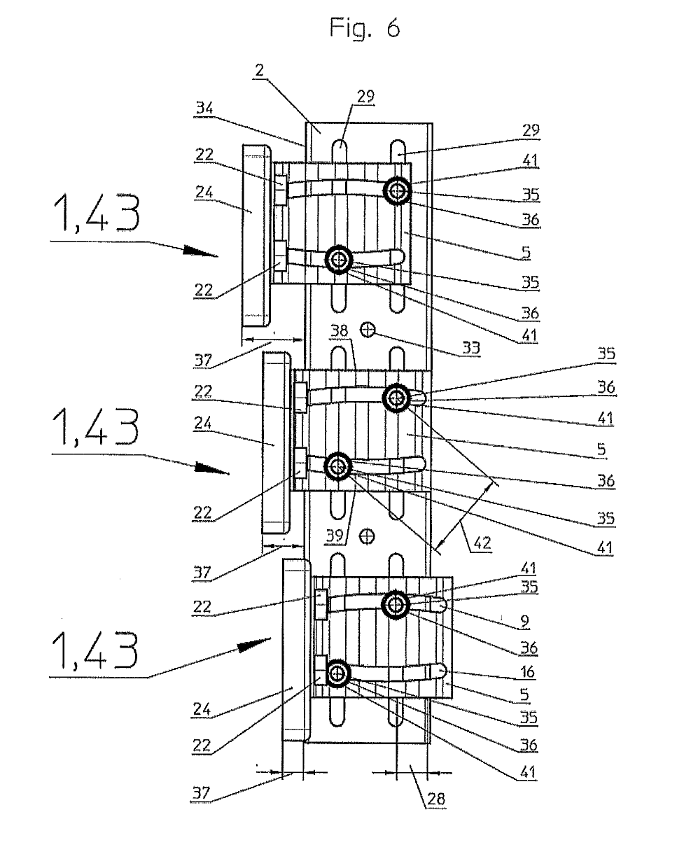

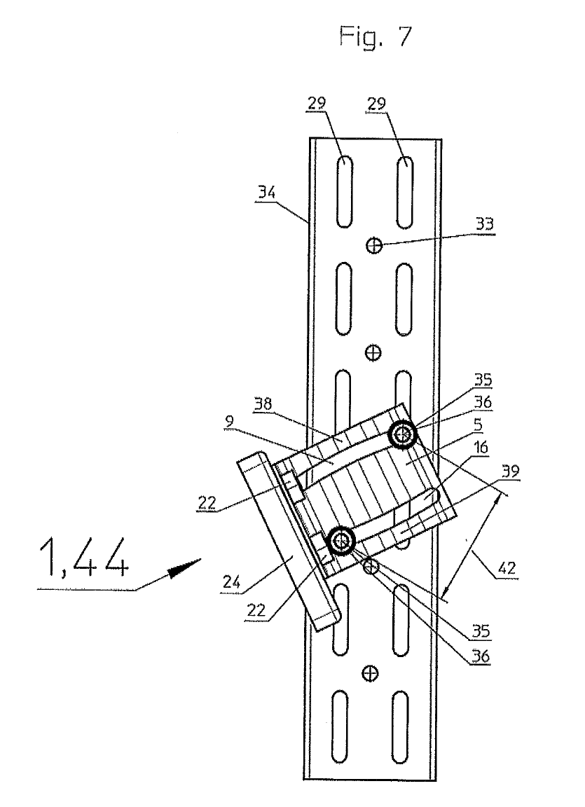

The side view of FIG. 1 shows an exemplary embodiment of a fastening element 1 according to the invention for the fixation of an anchor point 7 (see FIG. 5), which is especially suited to supporting of dynamic loads, and/or static loads on a metal profile 2 (see FIG. 6 and FIG. 7), especially reinforced steel wall systems, facing formwork, or suspended ceilings. The fastening element 1 comprises an angle-shaped bracket 3 with a first leg 4 and a second leg 5. FIG. 1 shows a view of an inner surface 15 of the second leg 5. Clearly seen are a first oblong hole 9 and a second oblong hole 16 in the second leg 5, which serve for fastening the angle-shaped bracket 3 to the metal profile 2 by a screw fastener.

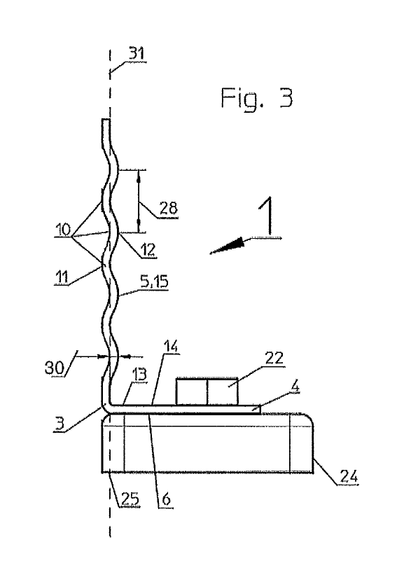

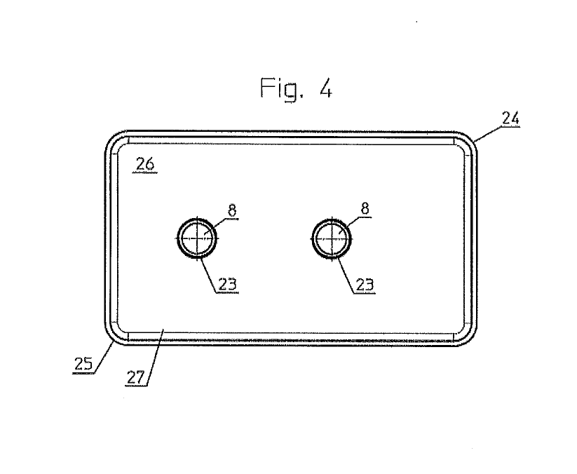

The first leg 4 has an inner surface 14 (see FIG. 3), on which two insert nuts 22 are fixed. These serve as a connection means with inner thread 8 (see FIG. 4) for the attachment of the anchor point 7 to the fastening element 1.

In order to recess the anchor point 7 in its mounting, a box-like container 24 is provided, whose back side 26 is formed by a connection plate 6. The connection plate 6 in turn guarantees a flat placement of the anchor point 7 and thus an optimal transfer of the load to the fastening element 1 in event of a protected fall.

The box-like container 24 moreover comprises a front side 25, which is ideally flush with a surface of a paneling (not shown) of the metal profile 2 and has an opening 27.

A depth 40 of the box-like container 1 results from a distance, measured normal to the back side 26, between back side 26 and front side 2. This depth 40 makes it possible to accommodate the anchor point 7 without it sticking out from the surface of the paneling (not shown). In the exemplary embodiment shown, the opening 27 extends essentially over the entire front side 25, as can be seen in the front view of the fastening element 1 shown in FIG. 4, looking at the box-like container 24. Also recognizable in FIG. 4 are mounting openings 23, which are arranged above the inner threads 8 of the insert nuts 22, in order to make possible an easy screwing of the anchor point 7 to the fastening element 1.

FIG. 5 shows a front view of the fastening element 1, looking at the box-like container 24 with anchor point 7 mounted in place. The anchor point 7 is connected to the fastening element 1 by screws 32 fitting into the inner thread 8 of the insert nuts 22 and thus it is fully accommodated in the box-like container 24.

When the fastening element 1 is not being used, a mounting core (not shown) can be arranged in the box-like container 24, totally closing the opening 27 and thus preventing dirt and grime from getting into the box-like container 24. Preferably, this mounting core is made of pressure-resistant plastic and it can also be plastered over, sealed and painted over.

FIG. 3 shows a view of the fastening element 1, in which the L shape formed by the first leg 4 and second leg 5 is especially well seen. The plane of the drawing is normal to the two inner surfaces 14, 15, which intersect at an edge 13 (also see FIG. 1). The edge 13 is normal to the plane of the drawing of FIG. 3. In the exemplary embodiment shown in FIG. 3, the angle measured in the plane of the drawing enclosed by the inner surfaces 14, 15 is 90°. In general, in any case, this angle is less than 180°.

It is also well seen in FIG. 3 that the second leg 5 has a corrugation 10 with wave peaks 11 and valleys 12. In the exemplary embodiment shown, the corrugation 10 extends over the entire second leg 5. The wave peaks 11 and valleys 12 stick out from a plane 31 of the second leg 5. The wave peaks 11 characterize an amplitude 30 of the corrugation 10 in a direction pointing away from the plane 31 of the second leg 5, which in the exemplary embodiment shown is normal to the plane 31. The wave valleys 12 characterize the amplitude 30 in the opposite direction. The distance between two consecutive wave peaks 11 or two wave valleys 12 defines a wavelength 28, while this distance is measured in the plane 31 and normal to the direction of extent of the wave peaks 11 or valleys 12.

In the exemplary embodiment shown in FIG. 3, the wave peaks 11 and valleys 12 extend in a straight line parallel to the edge 13, i.e., their direction of extent is normal to the plane of the drawing. The orientation of the direction of extent of the wave peaks 11 and valleys 12, in any case, is chosen so that the angle enclosed with the edge 13, measured in the plane 31, is not equal to 90°. This is because the edge 13 usually runs parallel to a front face 34 (see FIG. 6 and FIG. 7) of the metal profile 2 when the fastening element 1 is mounted on the metal profile 2 and as yet no dynamic loading has occurred, especially no loading as defined in standard EN 795 for anchor points of class A1. In event of a load with sufficiently large directional component normal to the edge 13 or normal to the direction of extent of the wave peaks 11 and valleys 12 of the fastening element 1 shown in FIG. 3, a plastic deformation of the second leg 5 can occur by stretching or compression of the corrugation 10. Upon stretching, the amplitude 30 decreases; upon compression, it increases. Thanks to this plastic deformation, energy can be absorbed and the load acting on the metal profile 2 can be reduced.

FIG. 6 shows a side view of a metal profile 2 with three fastening elements 1 mounted on it. The mounting of each fastening element 1 is done by screw fastening, each time arranging a screw 35 in the oblong holes 9, 16 of the fastening element 1. The metal profile 2, in turn, has oblong holes 29, which in the exemplary embodiment shown are arranged in two rows along the lengthwise dimension of the metal profile 2. Between the two rows of oblong holes 29 is arranged a row of round holes 33. For the screwing together with the fastening element 1, the oblong holes 29 will be used, i.e., each screw 35 is arranged not only in one oblong hole 9, 16 of the fastening element 1, but also in an oblong hole 29 of the metal profile 2.

The fastening elements 1 are secured to the metal profile 2 such that the front sides 25 of the box-like containers 24 are arranged parallel to the front face 34 of the metal profile 2. The oblong holes 9, 16 of the fastening elements 1 allow an adjusting of the distance 37 between the respective front side 25 and the front face 34. In FIG. 6 this is illustrated by means of the three fastening elements 1, where the distance 37 for the uppermost fastening element 1 in the drawing is the largest and for the lowermost fastening element 1 in the drawing it is the smallest. For the middle fastening element 1 in the drawing, the distance 37 lies between these two extreme values. In this way, one can allow for different thicknesses of the paneling (not shown) mounted on the front face 34, so that the front side 25 of the box-like container 24 is flush with the surface of the paneling (not shown).

In a typical dynamic load case, the dominant directional component of the load runs parallel to the front face 34 of the metal profile 2 and thus parallel to the edge 13 at first. If the directional component of the dynamic load running parallel to the front face 34 is large enough, the fastening element 1 will rotate against the friction acting between the second leg 5 and the metal profile 2. In this way, energy being absorbed is transformed into heat and the load on the metal profile 2 is decreased.

The oblong holes 9, 16 of the fastening elements 1 are curved in order to allow for the rotation. Accordingly, the screws 35 not only slip in the oblong holes 9, 16 of the fastening element 1, but also in the oblong holes 29 of the metal plate 2, when the fastening elements 1 are moved normal to the front face 34 of the metal profile 2 in order to allow for the thickness of the paneling.

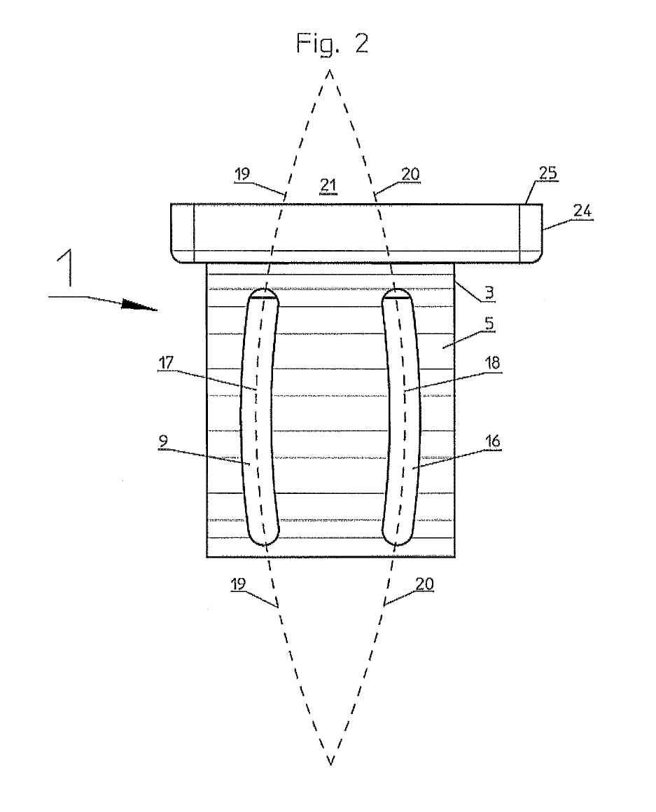

FIG. 2 shows another side view of the fastening element 1, in which the curved oblong holes 9, 16 are especially well seen. The first oblong hole 9 runs along a first imaginary circular arc 17 (shown by broken line). The second oblong hole 16 runs along a second imaginary circular arc 18 (also shown by broken line). The first imaginary circular arc 17 and the second imaginary circular arc 18 have opposite curvature, but no common midpoint. Furthermore, they are arranged so that extensions 19 of the imaginary first circular arc 17 intersect with extensions 20 of the imaginary second circular arc 18. The extensions 19, 20 are likewise shown by broken line in FIG. 2. Thus, a common surface 21 is subtended by the circular arcs 17, 18 together with the extensions 19, 20. This lies partly outside the second leg 5.

When the second leg 5 is screwed in place, the corrugation 10 is pressed against the metal profile 2, i.e., there does not exist a complete contact between the second leg 5 and the metal profile 2. With a washer 36, whose diameter is larger than half the wavelength 28, an elastic deformation of the corrugation 10 is produced at least in the region of the respective screw 35 by tightening a nut 41. The corrugation 10 is pressed together like a spring, i.e., the amplitude 30 is reduced. In order to ensure this elasticity on the one hand and the necessary plastic deformability on the other hand, the angle-shaped bracket 3 is made of metal.

As already described above, a rotation of the fastening element 1 occurs at first under a dynamic load with sufficiently large directional component parallel to the front face 34. More precisely, there is a first rotation of the fastening element 1, wherein the screw 35 in the second oblong hole acts as a pivot point or pivot axis and the first oblong hole 9 as a guide for the screw 35 arranged in the oblong hole 9. In this process, energy is dissipated by being transformed into heat, since the first rotation occurs under friction between the second leg 5 and the metal profile 2. The first rotation ends, clearly, when the end of the first oblong hole 9 is reached.

Depending on the remaining load and the precise position of the screw 35 in the second hole 16, an additional second rotation can occur afterwards, during which the screw 35, which is arranged in the first oblong hole 9 and contacts its end, acts as a pivot point or pivot axis. The second rotation ends when the end of the second oblong hole 16 is reached, i.e., when the screw 35 in the second oblong hole 16 contacts its end. Of course, energy is also dissipated as heat in the second rotation, since the second rotation also occurs under friction between the second leg 5 and the metal profile 2.

Even if the dynamic load originally does not have any directional component normal to the edge 13, but only a directional component parallel to the edge 13, after the rotation occurs there will be a directional component of the dynamic load which is normal to the edge 13.

If the directional component of the dynamic load normal to the edge 13 is large enough, there may result a plastic deformation by compression and/or stretching of the corrugation 10. For example, there can be a stretching of the corrugation 10 in a first deformation region 38 of the second leg 5 and a compression of the corrugation 10 in a second deformation region 39. In the example of FIG. 6 and FIG. 7, the first oblong hole 9 lies in the first deformation region 38 and the second oblong hole 16 in the second deformation region 39.

Finally, depending on the remaining load, there may occur a linear slippage of the fastening element 1 along the metal profile 2. In this case, the oblong holes 29 of the metal profile 2 act as guides in which the screws 35 move in linear fashion until they come up against the end of the particular oblong hole 29. Due to the friction between the second leg 5 and the metal profile 2, energy is also dissipated as heat during this linear slippage. The precise sequence of the first rotation, the second rotation of the linear slippage and the plastic deformation by compression/stretching of the corrugation 10 may vary, wherein details may play a role—such as the surface texture of the metal profile 2, the precise tightening torque of the screw or nut used to fasten the second leg 5 to the metal profile 2, the precise directional components of the applied load and their development over time, etc.

Furthermore, the precise initial positions of the two screws 35 are critical. Thus, there can clearly be no linear slippage when the two screws 35 are already arranged in their initial position 43 at the ends of the particular oblong holes 29.

FIG. 7 shows a fastening element 1 which has gone from an initial position 43, which is occupied by the middle fastening element 1 in FIG. 6, to an end position 44 by the first and second rotation and by linear slippage. In this end position 44, a distance 42 between the screw 35 in the first oblong hole 9 and the screw 35 in the second oblong hole 16 is greater than in the initial position 43. This distance 42 is measured in the plane 31 of the second leg 5, which in the case of FIG. 6 and FIG. 7 lies parallel to the plane of the drawing.

### LIST OF REFERENCE NUMBERS

1 fastening element
2 metal profile
3 angle-shaped bracket
4 first leg of angle-shaped bracket
5 second leg of angle-shaped bracket
6 connection plate
7 anchor point
8 internal thread
9 first oblong hole
10 corrugation
11 wave peak
12 wave valley
13 edge
14 inner surface of the first leg
15 inner surface of the second leg
16 second oblong hole
17 first imaginary circular arc
18 second imaginary circular arc
19 extension of the first imaginary circular arc
20 extension of the second imaginary circular arc
21 enclosed surface
22 insert nut
23 mounting opening
24 box-like container
25 front side of box-like container
26 back side of box-like container
27 opening
28 wavelength
29 oblong hole in metal profile
30 amplitude
31 plane of the second leg
32 screw for fastening an anchor point
33 round hole in metal profile
34 front face of metal profile
35 screw for screwing the second leg to the metal profile
36 washer
37 distance between front side of box-like container and front face of metal profile
38 first deformation region of second leg
39 second deformation region of second leg
40 depth of box-like container
41 nut
42 distance of screws for screwing together the second leg to the metal profile
43 starting position
44 end position

1-15. (canceled)

16. Fastening element (1) for the fixation of anchor points (7), which are especially suited to the supporting of dynamic loads, and/or static loads on metal profiles (2), especially those of reinforced steel wall systems, facing formwork, or suspended ceilings, comprising an angle-shaped bracket (3), with a first leg (4) and a second leg (5), wherein the first leg (4) and the second leg (5) have an L shape, wherein at least one connection means (22) is arranged on the first leg (4) for connecting the anchor point (7) and/or the static load to the fastening element (1) and the at least one connection means (22) preferably has an internal thread (8), wherein the second leg (5) is provided with a corrugation (10) at least for a portion, wherein the corrugation (10) has an amplitude (30) which extends out from a plane (31) of the second leg (5) in a direction normal to this plane (31) and is formed by wave peaks (11) and valleys (12), wherein points of equal phase of the fundamental wave lie on straight lines, so that the extension of the wave peaks (11) and valleys (12) is in a straight line, wherein the extension direction of the wave peaks (11) and valleys (12) encloses with one edge (13) an angle not equal to 90°, measured in the plane (31) of the second leg (5), or runs parallel to the edge (13), while along the edge (13) an inner surface (14) of the first leg (4) and an inner surface (15) of the second leg (5) intersect and wherein the inner surfaces (14, 15) enclose an angle less than 180°, measured in a plane which is normal to the edge (13), and there are two openings provided in the second leg (5) for screwing the second leg (5) to a metal profile (2), which are configured as oblong holes (9, 16).

17. Fastening element (1) according to claim 16, wherein the corrugation (10) has a constant wavelength (28).

18. Fastening element (1) according to claim 16, wherein the corrugation (10) extends over the entire second leg (5).

19. Fastening element (1) according to claim 16, wherein the two oblong holes (9, 16) are curved, and the curvature of the one oblong hole (9) is opposite the curvature of the other oblong hole (16).

20. Fastening element (1) according to claim 19, wherein the two oblong holes (9, 16) each run along an imaginary circular arc (17, 18) and the imaginary circular arcs (17, 18) have no common midpoint of the circle.

21. Fastening element (1) according to claim 20, wherein extensions (19, 20) of the imaginary circular arcs (17, 18) each time intersect the other imaginary circular arc (17, 18) and/or the extension (19, 20) of the other imaginary circular arc (17, 18).

22. Fastening element (1) according to claim 16, wherein two threaded sleeves or insert nuts (22) are fixed to the inner surface (14) of the first leg (4) as connection means.

23. Fastening element (1) according to claim 16, wherein a connection plate (6) is arranged on the first leg (4), in order to enable a planar bearing of the anchor point (7) and/or the static load against the fastening element (1).

24. Fastening element (1) according to claim 23, wherein the connection plate (6) is formed by the first leg (4).

25. Fastening element (1) according to claim 23, wherein the connection plate (6) has a mounting opening (23) above each of the inner threads (8) of the threaded sleeves or insert nuts (22) to enable the connecting of the anchor point (7) and/or the static load to the fastening element (1) by a screw fastening.

26. Fastening element (1) according to claim 23, wherein the connection plate (6) is arranged on a back side (26) of a box-like container (23) or forms this back side (26), while the box-like container (23) furthermore has a front side (25) and an opening (27) is arranged on the front side (25).

27. Fastening element (1) according to claim 16, wherein the angle-shaped bracket (3) is made of metal.

28. Use of the fastening element (1) according to claim 16, for the fixation of anchor points (7), which are especially suited to supporting of dynamic loads, and/or static loads on metal profiles (2), especially reinforced steel wall systems, facing formwork, or suspended ceilings, wherein the second leg (5) is elastically deformed when screwed together with the metal profile (2) and the amplitude (30) is reduced as compared to the unscrewed state at least for a portion.
